(19) United States
(12) Patent Application Publication
(10) Pub. No.: US 2019/0182645 A1
(43) Pub. Date: Jun. 13, 2019

(54) PROVISIONING MECHANISM TO TRIGGER A SUBSCRIPTION DOWNLOAD AT A USER EQUIPMENT

(71) Applicant: QUALCOMM Incorporated, San Diego, CA (US)

(72) Inventors: Vinay JOSEPH, San Diego, CA (US); Rajat PRAKASH, San Diego, CA (US); Miguel GRIOT, La Jolla, CA (US)

(21) Appl. No.: 16/211,883

(22) Filed: Dec. 6, 2018

Related U.S. Application Data
(60) Provisional application No. 62/596,604, filed on Dec. 8, 2017.

(51) Int. Cl. H04W 4/50; H04W 8/18

(52) U.S. Cl. CPC H04W 4/50; H04W 8/18

(57) ABSTRACT

In an aspect of the disclosure, a method, a computer-readable medium, and an apparatus are provided. In certain configurations, the apparatus may include a UE. The apparatus may send a first subscription request message to a provisioning entity. In certain aspects, the first subscription request message may request one or more subscriptions. In certain other aspects, each subscription may include at least one or more credentials. The apparatus may receive the one or more subscriptions from the provisioning entity when the one or more subscriptions are available. The apparatus may send a second subscription request message after a polling interval to the provisioning entity when the one or more subscriptions are not received. In certain aspects, the second subscription request message may be sent when the one or more subscriptions are not received in response to the first subscription request.

### CROSS-REFERENCE TO RELATED APPLICATION(S)

This application claims the benefit of U.S. Provisional Application Ser. No. 62/596,604, entitled “PROVISIONING MECHANISM TO TRIGGER A SUBSCRIPTION DOWNLOAD AT A USER EQUIPMENT” and filed on Dec. 8, 2017, which is expressly incorporated by reference herein in its entirety.

### BACKGROUND

### Technical Field

The present disclosure relates generally to communication systems, and more particularly, to a provisioning mechanism to trigger a subscription download at a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In order to gain initial access to a wireless network, a UE may first connect to a provisioning network that provisions the UE with credentials to access the wireless network. The UE may connect to the provisioning network using provisioning credentials that are not customized for the UE, and may be preconfigured at the UE prior to use. The provisioning credentials preconfigured at the UE may be replaced with customized credentials that enable access to the wireless network.

Once a connection with the provisioning network is established, a provisioning entity in the provisioning network may trigger a subscription download by sending a short message service (SMS) message and/or an internet protocol (IP) multimedia subsystem (IMS) message to the UE. The subscription downloaded by the UE may provide customized credentials that may be used to access the wireless network.

However, certain private networks, such as a wireless network dedicated for devices in a factory, may not have the infrastructure to support SMS messaging and/or IMS messaging. Thus, there is a need for a provisioning mechanism that triggers a subscription download at a UE without using SMS messaging and/or IMS messaging.

The present disclosure provides a solution by enabling the UE to poll the provisioning entity for any available subscriptions without waiting for a trigger (e.g., SMS message and/or IMS message) to be sent from the provisioning entity before initiating subscription download.

In an aspect of the disclosure, a method, a computer-readable medium, and an apparatus are provided. In certain configurations, the apparatus may include a UE. The apparatus may send a first subscription request message to a provisioning entity. In certain aspects, the first subscription request message may request one or more subscriptions. In certain other aspects, each subscription may include at least one or more credentials. The apparatus may receive the one or more subscriptions from the provisioning entity when the one or more subscriptions are available. The apparatus may send a second subscription request message after a polling interval to the provisioning entity when the one or more subscriptions are not received. In certain aspects, the second subscription request message may be sent when the one or more subscriptions are not received in response to the first subscription request.

In certain other configurations, the apparatus my include a provisioning entity. The apparatus may receive a first subscription request message from a UE. In certain aspects, the first subscription request message may request one or more subscriptions. In certain other aspects, each subscription may include at least one or more credentials. In certain other aspects, the first subscription request message may be associated with one or more of internet protocol (IP) information associated with the UE or an identifier of a serving network of the UE. The apparatus may send the one or more subscriptions to the UE when the one or more subscriptions are available. The apparatus may maintain a correlation between the one or more of IP information associated with the UE or an identifier of a serving network of the UE, and the requested one or more subscriptions when the one or more subscriptions are not available. The apparatus may initiate the sending of the one or more subscriptions to the UE using the one or more of IP information associated with the UE or the identifier of the serving network of the UE when the one or more subscriptions are ready without receiving a subsequent subscription request message from the UE.

In certain other configurations, the apparatus may receive a first subscription request message from a UE. In certain aspects, the first subscription request message may request one or more subscriptions. In certain other aspects, each subscription may include at least one or more credentials. The apparatus may send the one or more subscriptions to the UE when the one or more subscriptions are available. The apparatus may send at least a polling interval to the UE when the one or more subscriptions are not available. In certain aspects, the polling interval may be determined based on one or more of information stored in the provisioning entity or information sent by the UE. In certain other aspects, the information sent by the UE may include one or more of polling interval stored in the UE, UE type, subscription request index, battery state of the UE, or an IP address change detected by the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL subframe, DL channels within the DL subframe, an UL subframe, and UL channels within the UL subframe, respectively, for a 5G/NR frame structure.

FIG. 3 is a diagram illustrating an example of a base station and a UE in an access network.

FIG. 4 is a data flow that may be used by a UE to poll a provisioning entity for available subscriptions without waiting for a trigger to initiate subscription download in accordance with certain aspects of the disclosure.

FIG. 5 is a flowchart of a method of wireless communication.

FIG. 6 is a conceptual data flow diagram illustrating the data flow between different means/components in an exemplary apparatus.

FIG. 7 is a diagram illustrating an example of a hardware implementation for an apparatus employing a processing system.

FIG. 8 is a flowchart of a method of wireless communication.

FIG. 9 is a conceptual data flow diagram illustrating the data flow between different means/components in an exemplary apparatus.

FIG. 10 is a diagram illustrating an example of a hardware implementation for an apparatus employing a processing system.

FIG. 11 is a flowchart of a method of wireless communication.

FIG. 12 is a conceptual data flow diagram illustrating the data flow between different means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

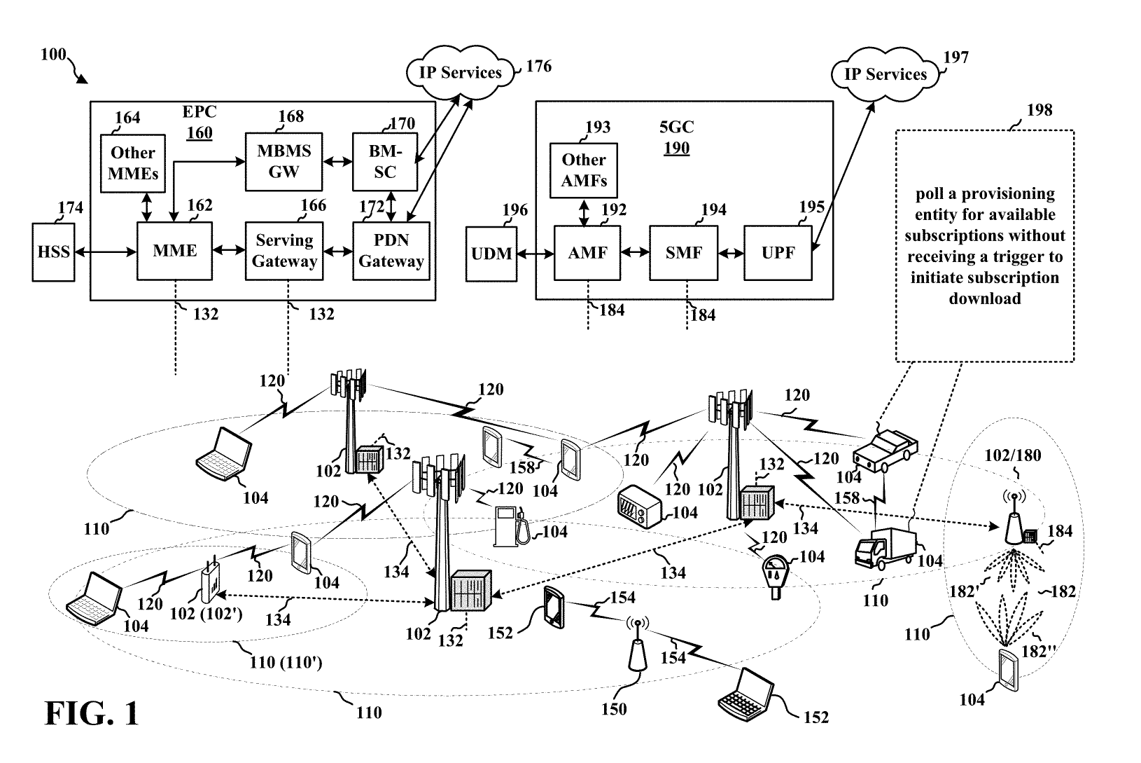

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and a 5G Core (5GC) 190. The base stations 102 may include macro cells (high power cellular base station) and/or small cells (low power cellular base station). The macro cells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

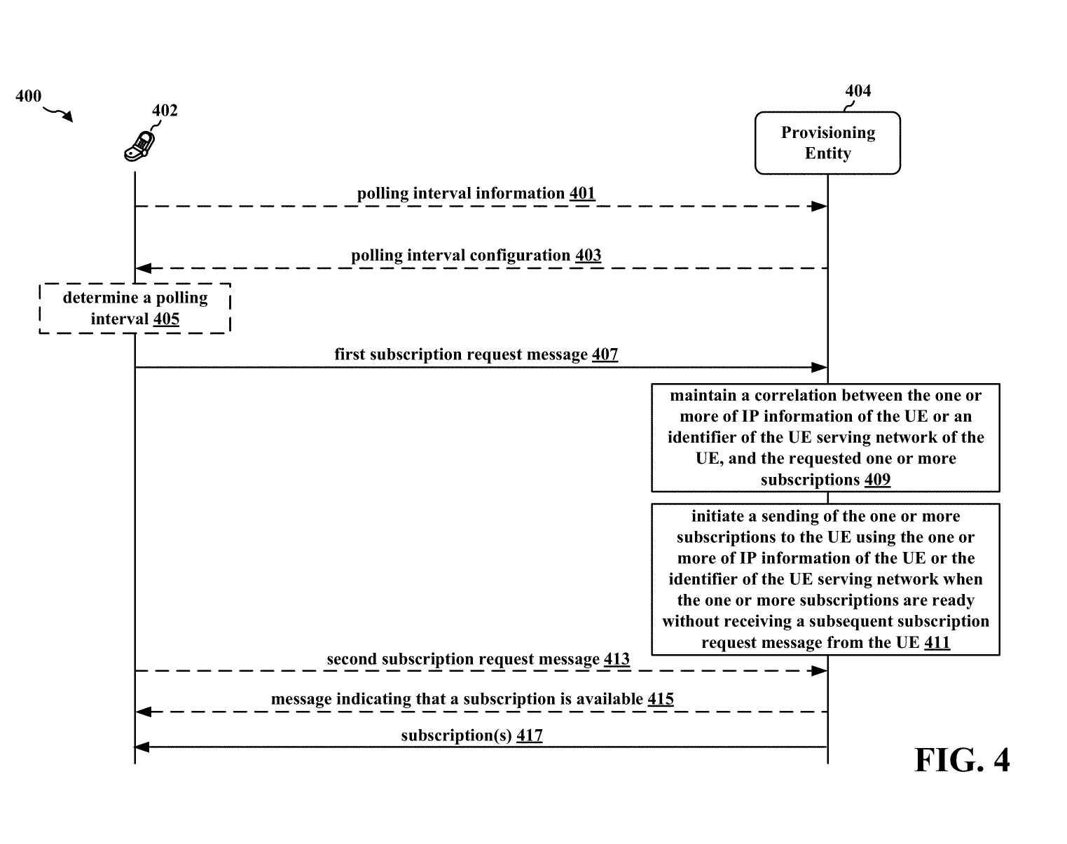

Referring again to FIG. 1, in certain aspects, the UE 104 may be configured to poll a provisioning entity for available subscriptions without receiving a trigger to initiate subscription download (198), e.g., as described below in connection with any of FIGS. 4-13.

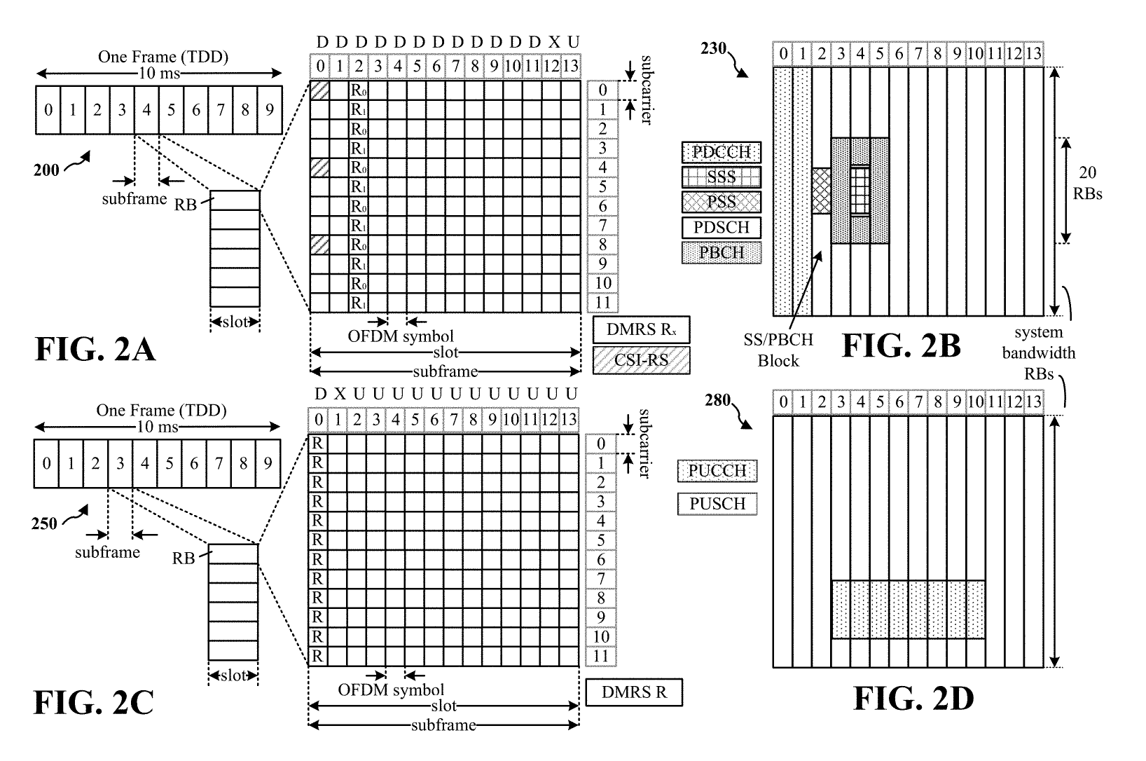

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

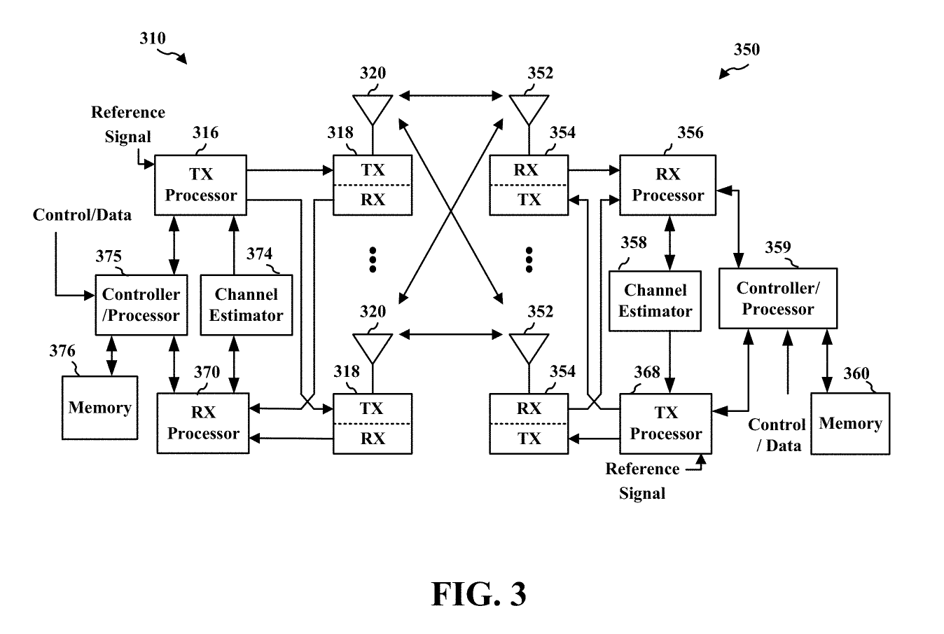

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In order to gain initial access to a wireless network, a UE may first connect to a provisioning network that provisions the UE with credentials to access the wireless network. The UE may connect to the provisioning network using provisioning credentials that are not customized for the UE, and may be preconfigured at the UE prior to use. The provisioning credentials preconfigured at the UE may be replaced with customized credentials that enable access to the wireless network.

Once a connection with the provisioning network is established, a provisioning entity in the provisioning network may trigger a subscription download by sending an SMS message and/or an IMS message to the UE. The subscription downloaded by the UE may provide customized credentials that may be used to access the wireless network.

However, certain private networks, such as a wireless network dedicated for devices in a factory, may not have the infrastructure to support SMS messaging and/or IMS messaging. Thus, there is a need for a provisioning mechanism that triggers a subscription download at a UE without using SMS messaging and/or IMS messaging.

The present disclosure provides a solution by enabling the UE to poll the provisioning entity for any available subscriptions without waiting for a trigger (e.g., SMS message and/or IMS message) to be sent from the provisioning entity before initiating subscription download. Using the technique(s) described below in connection with FIGS. 4-13, the flexibility of private network infrastructure may be increased by providing a mechanism to trigger a subscription download without requiring SMS and/or IMS infrastructure.

FIG. 4 is a data flow 400 that may be used by a UE 402 to poll a provisioning entity 404 for available subscriptions without waiting for a trigger to initiate subscription download in accordance with certain aspects of the disclosure. A subscription may comprise of one or more of subscription identifiers, subscription credentials, service provider identifiers, etc. Examples of subscription types may include an Universal Subscriber Identity Module based subscription (e.g., a USIM application) and a certificate based subscription.

The UE 402 may include a headless UE (e.g., a userless UE), an IoT device, a machine-type communication (MTC) device, or any type of wireless device that functions without user interaction. In certain configurations, the UE 402 may correspond to, e.g., UE 104, 350, 950, 1250, the apparatus 602/602′.

The provisioning entity 404 may include one or more nodes defined in Global System for Mobile Communications Association (GSMA) Remote Provisioning specifications and/or Remote SIM Provisioning (RSP) specifications, such as Subscription Manager-Secure Routing (SM-SR), Subscription Manager-Data Preparation (SM-DP), SM-DP+, Subscription Manager-Discovery Server (SM-DS), embedded universal integrated circuit card (eUICC) Manufacturer (EUM), Certificate Issuer (CI), network operator nodes, or an Online Sign-up (OSU) server defined in HotSpot 2.0 specifications, an OSU server defined in MulteFire Alliance specifications, an Enrollment over Secure Transport Server, or an authentication, authorization, and accounting (AAA) server or an OSU AAA server. In certain configurations, the provisioning entity 404 may correspond to, e.g., base station 102, 180, 310, provisioning entity 650, the apparatus 902/902′, 1202/1202′.

When the UE 402 initially powers-on, provisioning credentials preconfigured at the UE 402 may be used to gain access to a provisioning network that includes the provisioning entity 404. The provisioning network may be associated with a private network. In certain configurations, the provisioning network and/or private network may not include SMS and/or IMS infrastructure. In certain configurations, the provisioning network and/or private network may include SMS and/or IMS infrastructure. One example of a private network may be a wireless network dedicated for devices located within a factory or warehouse. For example, the private network may enable wireless communication between the devices located within the factory or warehouse that have access credentials for the private network, but not for devices that do not have credentials to access the private network. The UE 402 may initiate a subscription download using the techniques described below in connection with operations 401-417. The subscription(s) downloaded by the UE 402 may include one or more credentials that enable access to the private network. In FIG. 4, optional operations are indicated with dashed lines.

In certain aspects, the UE 402 may send (at 401) information that includes one or more of a current polling interval maintained by the UE 402 (e.g., a preconfigured polling interval), UE type (e.g., IoT device, MTC device, userless UE, etc.), subscription request index, battery state of the UE 402, or an IP address change detected by the UE 402 to the provisioning entity 404. A polling interval may be a duration between sending subscription request messages. In certain configurations, the UE 402 may send the information (sent at 401) before and/or after one or more subscription request message are sent (at 407, 413) to the provisioning entity 404.

In certain aspects, the provisioning entity 404 may send (at 403) information that configures the UE 402 with a polling interval (e.g., the same or different than the preconfigured polling interval) that may be used in polling the provisioning entity 404 for available subscription(s). In certain configurations, the information sent (at 403) by the provisioning entity 404 may be related to the information sent (at 401) by the UE 402.

The UE 402 may determine (at 405) the polling interval based at least in part on one or more of a current polling interval maintained by the UE, UE type, subscription request index, battery state of the UE, an IP address change detected by the UE, a change of a serving network identifier detected by the UE, a determination made by an application running in the UE that the UE needs a new subscription, unsatisfactory coverage for the current serving network detected by the UE, or unsatisfactory connectivity obtained using the current subscription detected by the UE. An example of unsatisfactory connectivity may include no connectivity (e.g., due to authentication failure), or limited connectivity (e.g., to limited number addresses, with limited bandwidth, etc.). In certain configurations, an application may track UE 402 movement and detect that the UE 402 is about to leave a current serving network and determine that the UE 402 may benefit from obtaining another subscription.

In certain configurations, the UE 402 may determine (at 405) the polling interval based on the information sent (at 403) by the provisioning entity 404. The provisioning entity 404 may additionally and/or alternatively configure the polling interval used by the UE 402 after one or more subscription request messages are received (at 407, 413) by the provisioning entity 404.

In certain other configurations, the UE 402 may determine (at 405) the polling interval without being configured by the provisioning entity 404. The UE 402 may determine a new polling interval based on a change in UE properties (e.g., battery power) before and/or after sending (at 407, 413) one or more subscription request messages to the provisioning entity 404.

Using the determine polling interval, the UE 402 may send (at 407) a first subscription request message requesting one or more subscription(s) to the provisioning entity 404. In certain aspects, each subscription indicated in the first subscription request message may include one or more credentials to access the private network. In certain other aspects, the first subscription request message may be associated with one or more of IP information of the UE 402 or an identifier of a serving network (e.g., the private network, other wireless networks, etc.) of the UE 402. In certain other aspects, the IP information may include an IP address associated with the UE 402.

In certain configurations, the provisioning entity 404 may maintain (at 409) a correlation between the one or more of IP information associated with the UE 402 or an identifier of a serving network of the UE 402, and the requested one or more subscriptions when the requested subscriptions are not available. Scenarios in which the one or more subscriptions may not be initially available include when the provisioning entity 404 customizes credentials for the UE 402 before sending the related subscriptions, when the provisioning entity 404 determines if the UE 402 has access rights to the private network (e.g., by checking an identifier of the UE 402 against a look-up table of private network accessible devices), and when the provisioning entity 404 determines if a threshold number of devices have gained access to the private network, etc.

Additionally and/or alternatively, the provisioning entity 404 may initiate (at 411) the sending of the one or more subscriptions to the UE 402 using the UE's 402 IP information and/or the identifier of the serving network of the UE 402 when the one or more subscriptions are ready without receiving a subsequent subscription request message from the UE 402. In certain configurations, the provisioning entity 404 may initiate (at 411) the sending of the one or more subscriptions by sending a Device Management (DM) Notification to a DM Client (e.g., at the UE 402 or another provisioning network device), as specified in Open Mobile Alliance DM specifications.

In certain configurations, the UE 402 may send (at 413) a second subscription request message. For example, the second subscription request message may be sent (at 413) when the UE 402 does not receive the one or more subscriptions in response to the first subscription request message (sent at 401). In other words, the UE 402 may send (at 413) the second subscription message after the polling interval (determined at 405) when the one or more subscriptions are not received within the polling interval associated with the first subscription request message.

In certain configurations, the UE 402 may send (at 407, 413) the first subscription request message and the second subscription request message when the provisioning entity 404 is determined to be trusted based on information maintained by the UE 402. A trusted provisioning entity 404 may be preferred over a non-trusted provisioning entity. The information maintained by the UE 402 may include one or more Fully Qualified Domain Names (FQDNs) of trusted servers, and the determination may include whether the server's authenticated FQDN is in the one or more FQDNs. A trusted server may be preferred over a non-trusted server.

In certain configurations, the provisioning entity 404 may send (at 415) a message indicating that a subscription for the UE 402 is available for provisioning. In certain configurations, a destination address of the message may be associated with one or more of the UE's 402 IP information or the identifier of the serving network of the UE 402. In certain configurations, the UE 402 may perform additional subscription download procedures with the provisioning entity 404 when the message is received (at 415) by the UE 402.

The provisioning entity 404 may send (at 417) the one or more subscriptions to the UE 402 when the one or more subscriptions are available, and/or based on the additional subscription download procedures performed with the UE 402. As mentioned above, UE 402 may access the private network using the credentials included in the one or more subscriptions.

Using the technique(s) described above in connection with FIG. 4, a UE 402 of the present disclosure may poll a provisioning entity 404 for available subscriptions without waiting for a trigger (e.g., SMS message and/or IMS message sent by the provisioning entity) to initiate subscription download. Hence, the flexibility of private network infrastructure may be increased by using the techniques described in connection with FIG. 4.

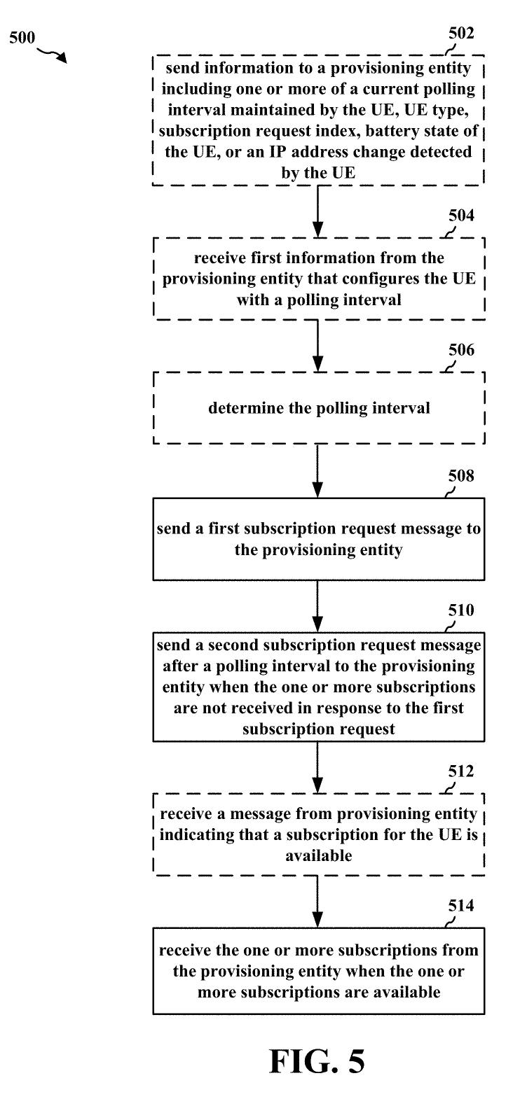

FIG. 5 is a flowchart 500 of a method of wireless communication. The method may be performed by a UE (e.g., UE 104, 350, 402, 950, 1150, the apparatus 602/602′). In FIG. 5, optional operations are indicated with dashed lines.

At 502, the UE may send second information (e.g., second information being sent before the first information received at operation 504) to the provisioning entity that includes one or more of a current polling interval maintained by the UE, UE type, subscription request index, battery state of the UE, or an IP address change detected by the UE. For example, referring to FIG. 4, the UE 402 may send (at 401) information that includes one or more of a current polling interval maintained by the UE 402 (e.g., a preconfigured polling interval), UE type (e.g., IoT device, MTC device, userless UE, etc.), subscription request index, battery state of the UE 402, or an IP address change detected by the UE 402 to the provisioning entity 404. A polling interval may be a duration between sending subscription request messages. In certain configurations, the UE 402 may send the information (sent at 401) before and/or after one or more subscription request message are sent (at 407, 413) to the provisioning entity 404.

At 504, the UE may receive first information (e.g., first information being received after second information is sent at operation 502) from the provisioning entity that configures the UE with the polling interval. In certain aspects, the first information may be based at least in part on the second information. For example, referring to FIG. 4, the provisioning entity 404 may send (at 403) information that configures the UE 402 with a polling interval (e.g., the same or different than the preconfigured polling interval) that may be used in polling the provisioning entity 404 for available subscription(s). In certain configurations, the information sent (at 403) by the provisioning entity 404 may be related to the information sent (at 401) by the UE 402.

At 506, the UE may determine the polling interval based at least in part on one or more of a current polling interval maintained by the UE, UE type, subscription request index, battery state of the UE, an IP address change detected by the UE, a change of a serving network identifier detected by the UE, a determination made by an application running in the UE that the UE needs a new subscription, unsatisfactory coverage for the current serving network detected by the UE, or unsatisfactory connectivity obtained using the current subscription detected by the UE. For example, referring to FIG. 4, the UE 402 may determine (at 405) the polling interval based at least in part on one or more of a current polling interval maintained by the UE, UE type, subscription request index, battery state of the UE, or an IP address change detected by the UE 402. In other words, the polling interval may be configurable based on UE properties such as, e.g., UE type, IP address, power constraints, etc. In certain configurations, in connection with FIG. 4, the UE 402 may determine (at 405) the polling interval based on the information sent (at 403) by the provisioning entity 404. The provisioning entity 404 may additionally and/or alternatively configure the polling interval used by the UE 402 after one or more subscription request messages are received (at 407, 413) by the provisioning entity 404. In certain other configurations, in connection with FIG. 4, the UE 402 may determine (at 405) the polling interval without being configured by the provisioning entity 404. The UE 402 may determine a new polling interval based on UE a change in UE properties (e.g., battery power) before and/or after sending (at 407, 413) one or more subscription request messages to the provisioning entity 404.

At 508, the UE may send a first subscription request message to a provisioning entity. In certain aspects, the first subscription request message may request one or more subscriptions. In certain other aspects, each subscription may include at least one or more credentials. In certain other aspects, the first subscription request message may be associated with one or more of IP information of the UE or an identifier of a serving network of the UE. In certain other aspects, the IP information may include an IP address associated with the UE. For example, referring to FIG. 4, the UE 402 may send (at 407) a first subscription request message requesting one or more subscription(s) to the provisioning entity 404. In certain aspects, each subscription indicated in the first subscription request message may include one or more credentials to access the private network. In certain other aspects, the first subscription request message may be associated with one or more of IP information of the UE 402 or an identifier of a serving network (e.g., the private network, other wireless networks, etc.) of the UE 402. In certain other aspects, the IP information may include an IP address associated with the UE 402.

At 510, the UE may send a second subscription request message after a polling interval to the provisioning entity when the one or more subscriptions are not received. In certain aspects, the second subscription request may be sent when the one or more subscriptions are not received in response to the first subscription request. In certain aspects, the first subscription request message and the second subscription request message may be sent when the provisioning entity is determined to be trusted and/or preferred based on information maintained by the UE. For example, referring to FIG. 4, when the UE 402 does not receive the one or more subscriptions in response to the first subscription request message (sent at 401), the UE 402 may send (at 413) a second subscription request message. In other words, the UE 402 may send (at 413) the second subscription message after the polling interval (determined at 405) when the one or more subscriptions are not received within the polling interval associated with the first subscription request message.

At 512, the UE may receive a message from provisioning entity indicating that a subscription for the UE is available for provisioning. In certain aspects, a destination address of the message may be associated with one or more the IP information of the UE or an identifier of the serving network of the UE. For example, referring to FIG. 4, the provisioning entity 404 may send (at 415) a message indicating that a subscription for the UE 402 is available for provisioning. In certain configurations, a destination address of the message may be associated with one or more of the UE's 402 IP information or the identifier of the serving network of the UE 402. In certain configurations, the UE 402 may perform additional subscription download procedures with the provisioning entity 404 when the message is received (at 415) by the UE 402.

At 514, the UE may receive the one or more subscriptions from the provisioning entity when the one or more subscriptions are available. For example, referring to FIG. 4, the UE 402 may receive (at 417) the one or more subscriptions sent by the provisioning entity 404 when the one or more subscriptions are available, and/or based on the additional subscription download procedures performed with the UE 402.

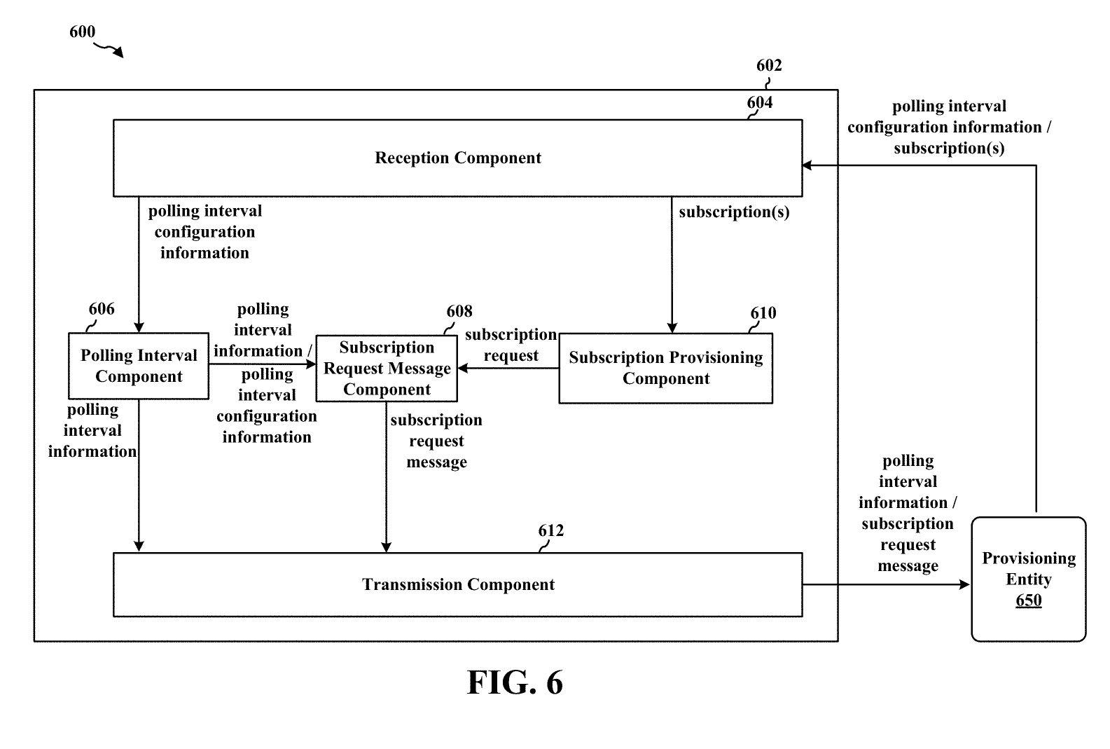

FIG. 6 is a conceptual data flow diagram 600 illustrating the data flow between different means/components in an exemplary apparatus 602. The apparatus may be a UE (e.g., UE 104, 350, 402, 950, 1150, the apparatus 602′) in communication with a provisioning entity 650 (e.g., base station 102, 180, 310, provisioning entity 650, the apparatus 902/902′, 1202/1202′). The apparatus may include a reception component 604, a polling interval component 606, a subscription request message component 608, a subscription provisioning component 610, and a transmission component 612.

The polling interval component 606 may be configured to send a signal associated with polling interval information to the transmission component 612. The polling interval information may include one or more of a current polling interval maintained by the UE, UE type, subscription request index, battery state of the UE, or an IP address change detected by the UE, wherein the first information is based at least in part on the second information.

In certain other configurations, the transmission component 612 may be configured to send the polling interval information (e.g., second information) to the provisioning entity 650.

In certain other configurations, the reception component 604 may be configured to receive polling interval configuration information (e.g., first information) from the provisioning entity 650 that configures the UE with the polling interval. In certain aspects, the first information may be based at least in part on the second information. The reception component 604 may be configured to send a signal associated with the polling interval configuration information to the polling interval component 606. The polling interval component 606 may be configured to send a signal indicated one or more of the polling interval information (e.g., preconfigured polling interval) and/or the polling interval configuration information to the subscription request message component 608.

In certain other configurations, the polling interval component 606 may be configured to determine the polling interval based at least in part on one or more of a current polling interval maintained by the UE, UE type, subscription request index, battery state of the UE, an IP address change detected by the UE, a change of a serving network identifier detected by the UE, a determination made by an application running in the UE that the UE needs a new subscription, unsatisfactory coverage for the current serving network detected by the UE, or unsatisfactory connectivity obtained using the current subscription detected by the UE.

In certain configurations, the subscription provisioning component 610 may be configured to send a signal indicating requested subscriptions to the subscription request message component 608.

In certain configurations, the subscription request message component 608 may be configured to generate a subscription request based on the signal received from the polling interval component 606 and/or the subscription provisioning component 610. The subscription request message component 608 may be configured to send a signal associated with one or more subscription request message(s) to the transmission component 612.

In certain configurations, the transmission component 612 may be configured to send a first subscription request message to the provisioning entity 650. In certain aspects, the first subscription request message may request one or more subscriptions. In certain other configurations, each subscription may include at least one or more credentials. In certain other aspects, the first subscription request message may be associated with one or more of IP information of the UE or an identifier of a serving network of the UE. In certain other aspects, the IP information may include an IP address associated with the UE.

In certain other configurations, the transmission component 612 may be configured to send a second subscription request message after a polling interval to the provisioning entity 650 when the one or more subscriptions are not received. In certain aspects, the second subscription request may be sent when the one or more subscriptions are not received in response to the first subscription request. In certain aspects, the first subscription request message and the second subscription request message may be sent when the provisioning entity is determined to be trusted and/or preferred based on information maintained by the UE.

In certain other configurations, the reception component 604 may be configured to receive a message from provisioning entity 650 indicating that a subscription for the UE is available for provisioning. In certain aspects, a destination address of the message may be associated with one or more the IP information of the UE or an identifier of the serving network of the UE. The reception component 604 may be configured to send a signal associated with the message indicated available subscriptions to the subscription provisioning component 610.

In certain other configurations, the reception component 604 may be configured to receive the one or more subscriptions from the provisioning entity when the one or more subscriptions are available. The reception component 604 may be configured to send a signal associated with the one or more subscriptions to the subscription provisioning component 610.

The apparatus may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

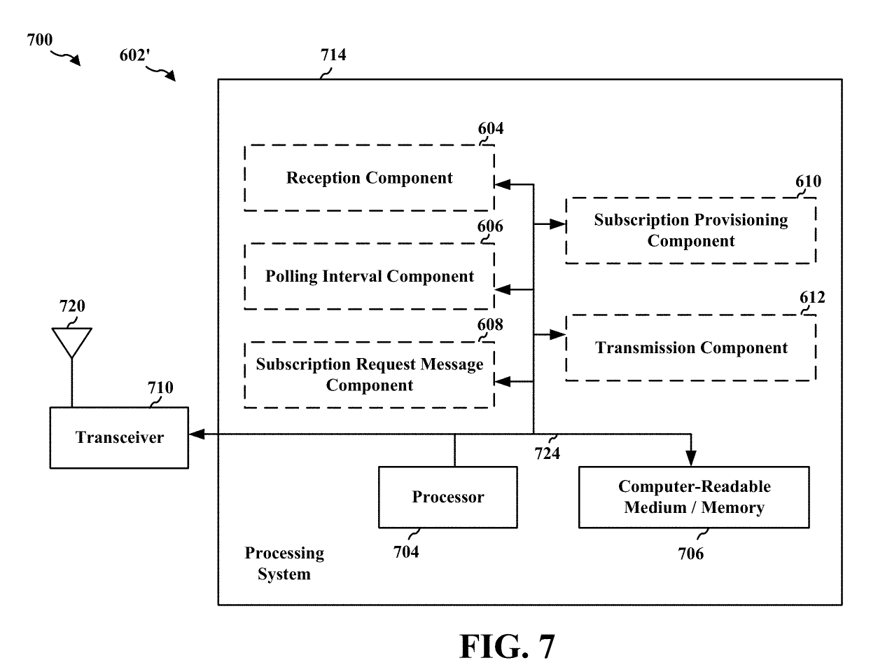

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware components, represented by the processor 704, the components 604, 606, 608, 610, 612 and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. The transceiver 710 receives a signal from the one or more antennas 720, extracts information from the received signal, and provides the extracted information to the processing system 714, specifically the reception component 604. In addition, the transceiver 710 receives information from the processing system 714, specifically the transmission component 612, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system 714 further includes at least one of the components 604, 606, 608, 610, 612. The components may be software components running in the processor 704, resident/stored in the computer readable medium/memory 706, one or more hardware components coupled to the processor 704, or some combination thereof. The processing system 714 may be a component of the UE 350 and may include the memory 360 and/or at least one of the TX processor 368, the RX processor 356, and the controller/processor 359.

In certain configurations, the apparatus 602/602′ for wireless communication may include means for sending second information to the provisioning entity that includes one or more of a current polling interval maintained by the UE, UE type, subscription request index, battery state of the UE, or an IP address change detected by the UE. In certain other configurations, the apparatus 602/602′ for wireless communication may include means for receiving first information from the provisioning entity that configures the UE with the polling interval. In certain aspects, the first information may be based at least in part on the second information. In certain other configurations, the apparatus 602/602′ for wireless communication may include means for determining the polling interval based at least in part on one or more of a current polling interval maintained by the UE, UE type, subscription request index, battery state of the UE, an IP address change detected by the UE, a change of a serving network identifier detected by the UE, a determination made by an application running in the UE that the UE needs a new subscription, unsatisfactory coverage for the current serving network detected by the UE, or unsatisfactory connectivity obtained using the current subscription detected by the UE. In certain other configurations, the apparatus 602/602′ for wireless communication may include means for sending a first subscription request message to a provisioning entity. In certain aspects, the first subscription request message may request one or more subscriptions. In certain other aspects, each subscription may include at least one or more credentials. In certain other aspects, the first subscription request message may be associated with one or more of IP information of the UE or an identifier of a serving network of the UE. In certain other aspects, the IP information may include an IP address associated with the UE. In certain other configurations, the apparatus 602/602′ for wireless communication may include means for sending a second subscription request message after a polling interval to the provisioning entity when the one or more subscriptions are not received. In certain configurations, the second subscription request may be sent when the one or more subscriptions are not received in response to the first subscription request. In certain aspects, the first subscription request message and the second subscription request message may be sent when the provisioning entity is determined to be trusted and/or preferred based on information maintained by the UE. In certain other configurations, the apparatus 602/602′ for wireless communication may include means for receiving a message from provisioning entity indicating that a subscription for the UE is available for provisioning. In certain aspects, a destination address of the message may be associated with one or more the IP information of the UE or an identifier of the serving network of the UE. In certain other configurations, the apparatus 602/602′ for wireless communication may include means for receiving the one or more subscriptions from the provisioning entity when the one or more subscriptions are available. The aforementioned means may be one or more of the aforementioned components of the apparatus 602 and/or the processing system 714 of the apparatus 602′ configured to perform the functions recited by the aforementioned means. As described supra, the processing system 714 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

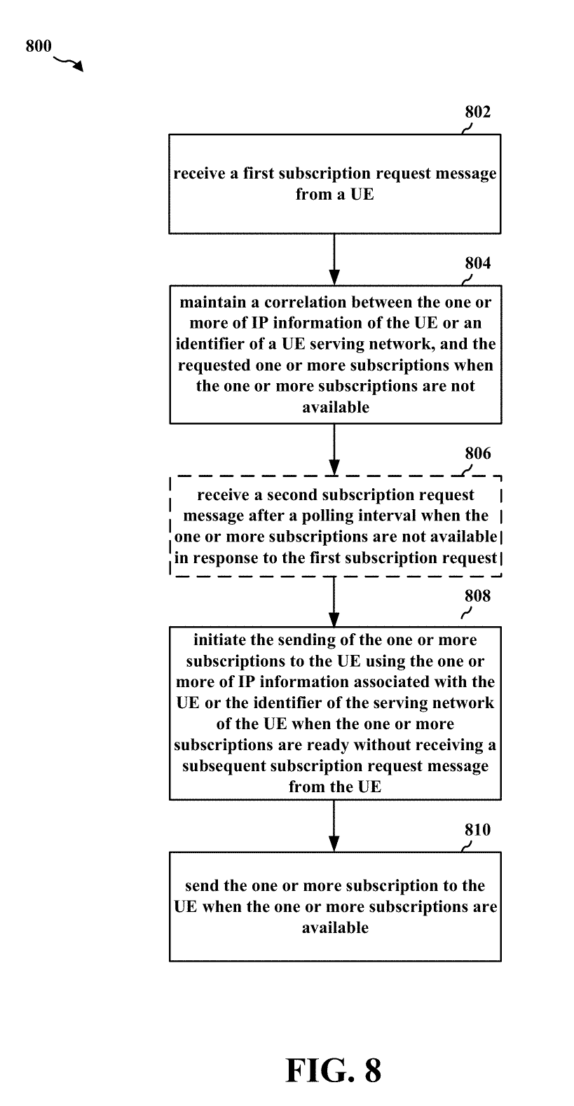

FIG. 8 is a flowchart 800 of a method of wireless communication. The method may be performed by a provisioning entity (e.g., base station 102, 180, 310, provisioning entity 650, the apparatus 902/902′, 1202/1202′). In FIG. 8, optional operations are indicated with dashed lines.

At 802, the provisioning entity may receive a first subscription request message from a UE. In certain aspects, the first subscription request message may request one or more subscriptions. In certain other aspects, each subscription may include at least one or more credentials. In certain other aspects, the first subscription request message may be associated with one or more of IP information associated with the UE or an identifier of a serving network of the UE. In certain other aspects, the IP information may include one or more of an IP address associated with the UE. For example, referring to FIG. 4, the provisioning entity 404 may receive (at 407) a first subscription request message requesting one or more subscription(s) from the UE 402. In certain aspects, each subscription indicated in the first subscription request message may include one or more credentials to access the private network. In certain other aspects, the first subscription request message may be associated with one or more of IP information of the UE 402 or an identifier of a serving network (e.g., the private network, other wireless networks, etc.) of the UE 402. In certain other aspects, the IP information may include an IP address associated with the UE 402.

At 804, the provisioning entity may maintain a correlation between the one or more of IP information associated with the UE or an identifier of a serving network of the UE, and the requested one or more subscriptions when the one or more subscriptions are not available. For example, referring to FIG. 4, the provisioning entity 404 may maintain (at 409) a correlation between the one or more of IP information associated with the UE 402 or an identifier of a serving network of the UE 402, and the requested one or more subscriptions when the requested subscriptions are not available. Scenarios in which the one or more subscriptions may not be initially available include when the provisioning entity 404 customizes credentials for the UE 402 before sending the related subscriptions, when the provisioning entity 404 determines if the UE 402 has access rights to the private network (e.g., by checking an identifier of the UE 402 against a look-up table of private network accessible devices), and when the provisioning entity 404 determines if a threshold number of devices have gained access to the private network, etc.

At 806, the provisioning entity may receive a second subscription request message after a polling interval when the one or more subscriptions are not available in response to the first subscription request. For example, referring to FIG. 4, the provisioning entity 404 may receive (at 413) a second subscription request message. In other words, the provisioning entity 404 may receive (at 413) the second subscription message after the polling interval when the one or more subscriptions are not available within the polling interval associated with the first subscription request message.

At 808, the provisioning entity may initiate the sending of the one or more subscriptions to the UE using the one or more of IP information associated with the UE or the identifier of the serving network of the UE when the one or more subscriptions are ready without receiving a subsequent subscription request message from the UE. For example, referring to FIG. 4, the provisioning entity 404 may initiate (at 411) the sending of the one or more subscriptions to the UE 402 using the UE's 402 IP information and/or the identifier of the serving network of the UE 402 when the one or more subscriptions are ready without receiving a subsequent subscription request message from the UE 402.

At 810, the provisioning entity may send the one or more subscriptions to the UE when the one or more subscriptions are available. For example, referring to FIG. 4, the provisioning entity 404 may send (at 417) the one or more subscriptions to the UE 402 when the one or more subscriptions are available, and/or based on the additional subscription download procedures performed with the UE 402.

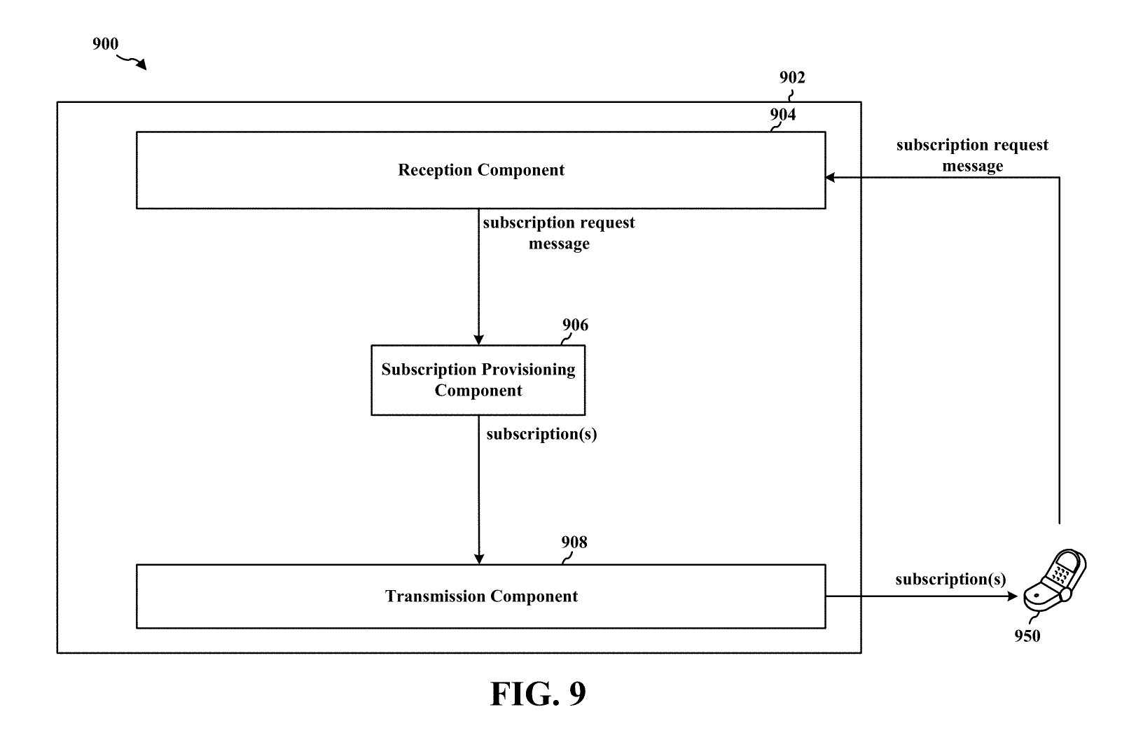

FIG. 9 is a conceptual data flow diagram 900 illustrating the data flow between different means/components in an exemplary apparatus 902. The apparatus may be a provisioning entity (e.g., base station 102, 180, 310, provisioning entity 650, the apparatus 902′, 1202/1202′) in communication with a UE 950 (e.g., UE 104, 350, 402, 1250, the apparatus 602/602′). The apparatus may include a reception component 904, a subscription provisioning component 906, and a transmission component 908.

The reception component 904 may be configured to receive a first subscription request message from a UE 950. In certain aspects, the first subscription request message may request one or more subscriptions. In certain other aspects, each subscription may include at least one or more credentials. In certain other aspects, the first subscription request message may be associated with one or more of IP information associated with the UE 950 or an identifier of a serving network of the UE 950. In certain other aspects, the IP information may include one or more of an IP address associated with the UE 950. The reception component 904 may be configured to send a signal associated with the first subscription request message to the subscription provisioning component 906.

In certain configurations, the subscription provisioning component 906 may be configured to determine if the one or more subscriptions requested in the first subscription request message are available for the UE 950. In certain other configurations, the subscription provisioning component 906 may be configured to maintain a correlation between the one or more of IP information associated with the UE or an identifier of a serving network of the UE 950, and the requested one or more subscriptions when the one or more subscriptions are not available.

In certain other configurations, the reception component 904 may be configured to receive a second subscription request message after a polling interval when the one or more subscriptions are not available in response to the first subscription request. The reception component 904 may be configured to send a signal associated with the second subscription request message to the subscription provisioning component 906.

In certain configurations, the subscription provisioning component 906 may be configured to determine if the one or more subscriptions requested in the subscription request message are available for the UE 950. The subscription provisioning component 906 may be configured to initiate the sending of the one or more subscriptions to the UE 950 using the one or more of IP information associated with the UE 950 or the identifier of the serving network of the UE 950 when the one or more subscriptions are ready without receiving a subsequent subscription request message from the UE 950. For example, the subscription provisioning component 906 may be configured to send a signal associated with the one or more subscriptions to the transmission component 908.

In certain configurations, the transmission component 908 may be configured to send the one or more subscriptions to the UE 950 when the one or more subscriptions are available.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

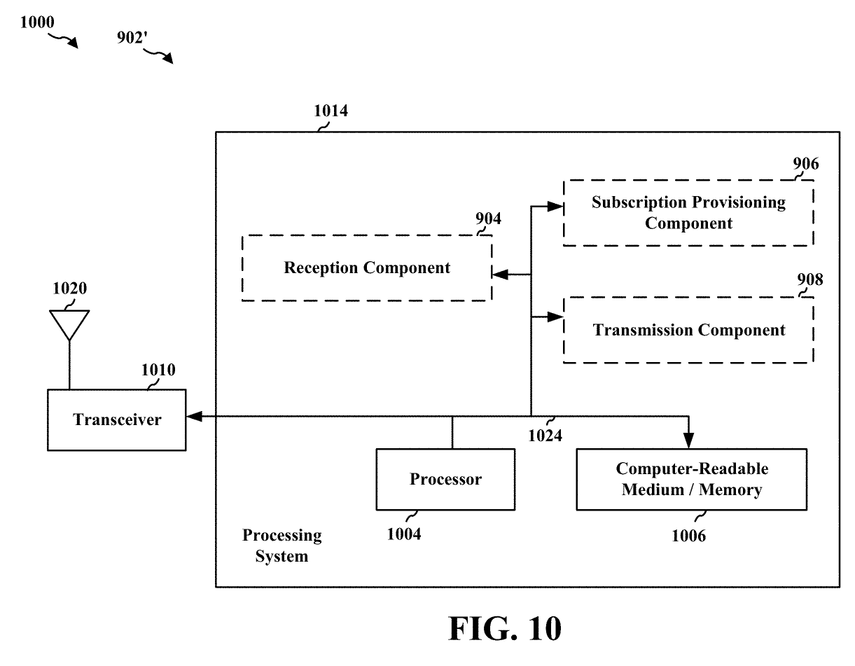

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, 908, and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, specifically the transmission component 908, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906, 908. The components may be software components running in the processor 1004, resident/stored in the computer readable medium/memory 1006, one or more hardware components coupled to the processor 1004, or some combination thereof. The processing system 1014 may be a component of the base station 310 and may include the memory 376 and/or at least one of the TX processor 316, the RX processor 370, and the controller/processor 375.

In certain configurations, the apparatus 902/902′ for wireless communication may include means for receiving a first subscription request message from a UE. In certain aspects, the first subscription request message may request one or more subscriptions. In certain other aspects, each subscription may include at least one or more credentials. In certain other aspects, the first subscription request message may be associated with one or more of IP information associated with the UE or an identifier of a serving network of the UE. In certain other aspects, the IP information may include one or more of an IP address associated with the UE. In certain configurations, the apparatus 902/902′ for wireless communication may include means for maintaining a correlation between the one or more of IP information associated with the UE or an identifier of a serving network of the UE, and the requested one or more subscriptions when the one or more subscriptions are not available. In certain configurations, the apparatus 902/902′ for wireless communication may include means for receiving a second subscription request message after a polling interval when the one or more subscriptions are not available in response to the first subscription request. In certain other configurations, the apparatus 902/902′ for wireless communication may include means for initiating the sending of the one or more subscriptions to the UE using the one or more of IP information associated with the UE or the identifier of the serving network of the UE when the one or more subscriptions are ready without receiving a subsequent subscription request message from the UE. In certain other configurations, the apparatus 902/902′ for wireless communication may include means for sending the one or more subscriptions to the UE when the one or more subscriptions are available. The aforementioned means may be one or more of the aforementioned components of the apparatus 902 and/or the processing system 1014 of the apparatus 902′ configured to perform the functions recited by the aforementioned means. As described supra, the processing system 1014 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

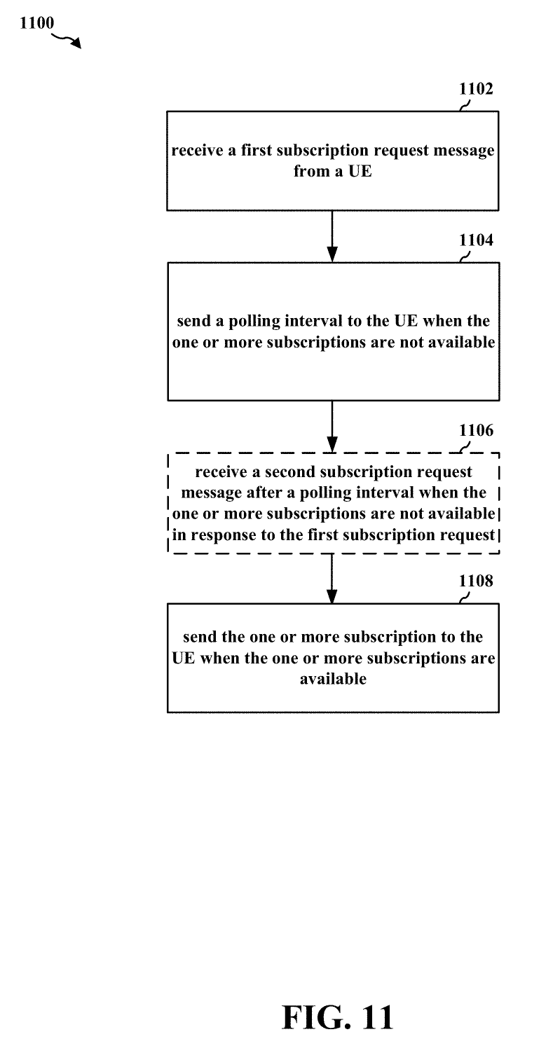

FIG. 11 is a flowchart 1100 of a method of wireless communication. The method may be performed by a provisioning entity (e.g., base station 102, 180, 310, provisioning entity 650, the apparatus 902/902′, 1202/1202′). In FIG. 11, optional operations are indicated with dashed lines.

At 1102, the provisioning entity may receive a first subscription request message from a UE. In certain aspects, the first subscription request message may request one or more subscriptions. In certain other aspects, each subscription may include at least one or more credentials. For example, referring to FIG. 4, the provisioning entity may receive (at 407) a first subscription request message requesting one or more subscription(s) from the UE 402. In certain aspects, each subscription indicated in the first subscription request message may include one or more credentials to access the private network. In certain other aspects, the first subscription request message may be associated with one or more of IP information of the UE 402 or an identifier of a serving network (e.g., the private network, other wireless networks, etc.) of the UE 402. In certain other aspects, the IP information may include an IP address associated with the UE 402.

At 1104, the provisioning entity may send at least a polling interval to the UE when the one or more subscriptions are not available. In certain aspects, the polling interval may be determined based on one or more of information stored in the provisioning entity or information sent by the UE. In certain other aspects, the information sent by the UE may include one or more of polling interval stored in the UE, UE type, subscription request index, battery state of the UE, or an IP address change detected by the UE. For example, referring to FIG. 4, the provisioning entity 404 may send (at 403) information that configures the UE 402 with a polling interval (e.g., the same or different than the preconfigured polling interval) that may be used in polling the provisioning entity 404 for available subscription(s). In certain configurations, the information sent (at 403) by the provisioning entity 404 may be related to the information sent (at 401) by the UE 402.

At 1106, the provisioning entity may receive a second subscription request message after the polling interval when the one or more subscriptions are not available in response to the first subscription request. For example, referring to FIG. 4, when the provisioning entity does not send the one or more subscriptions in response to the first subscription request message (received at 401), the provisioning entity may receive (at 413) a second subscription request message from the UE 402. In other words, the provisioning entity may receive (at 413) the second subscription message after the polling interval (determined by the UE 402 at 405) when the one or more subscriptions are not sent by the provisioning entity 404 within the polling interval associated with the first subscription request message.

At 1108, the provisioning entity may send the one or more subscriptions to the UE when the one or more subscriptions are available. For example, referring to FIG. 4, the provisioning entity 404 may send (at 417) the one or more subscriptions to the UE 402 when the one or more subscriptions are available, and/or based on the additional subscription download procedures performed with the UE 402.

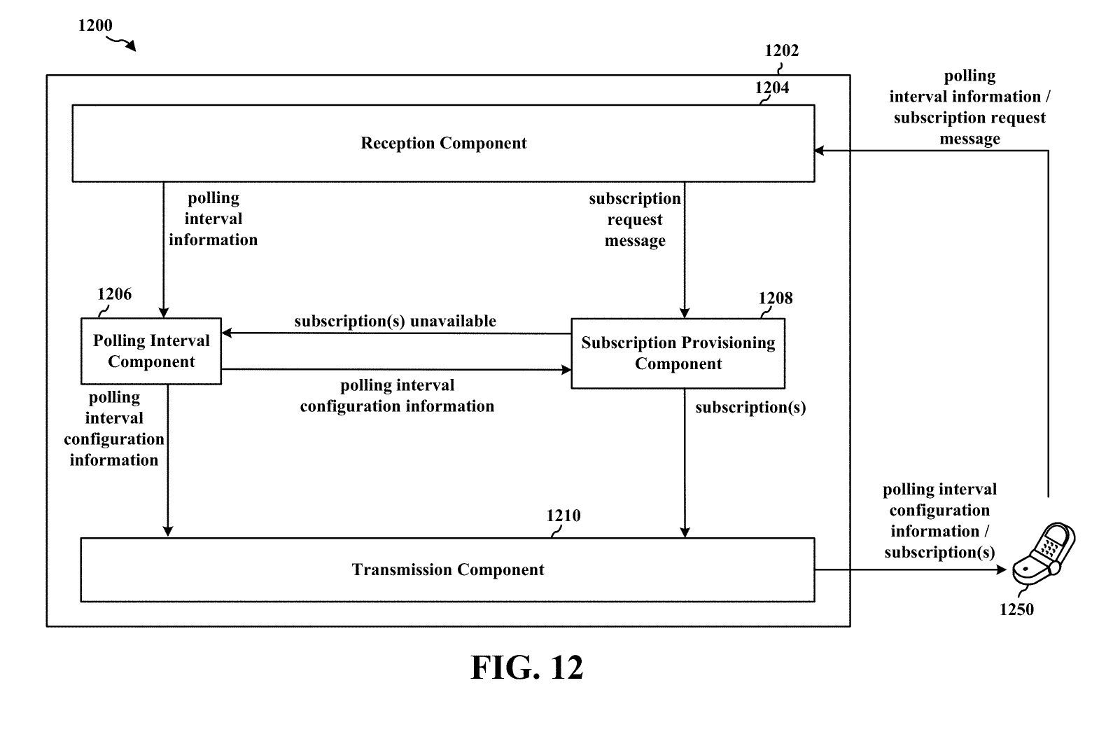

FIG. 12 is a conceptual data flow diagram 1200 illustrating the data flow between different means/components in an exemplary apparatus 1202. The apparatus may be a provisioning entity (e.g., base station 102, 180, 310, provisioning entity 650, the apparatus 902/902′, 1202′) in communication with a UE 1250 (e.g., UE 104, 350, 402, 950, the apparatus 602/602′). The apparatus may include a reception component 1204, a polling interval component 1206, a subscription provisioning component 1208, and a transmission component 1210.

In certain configurations, the reception component 1204 may be configured to receive a first subscription request message from a UE 1250. In certain aspects, the first subscription request message may request one or more subscriptions. In certain other aspects, each subscription may include at least one or more credentials. The reception component 1204 may be configured to send a signal associated with the first subscription request message to the subscription provisioning component 1208. The subscription provisioning component 1208 may be configured to determine if the one or more subscriptions are available for the UE 1250. The subscription provisioning component 1208 may be configured to send a signal indicating the subscription(s) are not available for the UE 1250 to the polling interval component 1206.

In certain other configurations, the reception component 1204 may be configured to receive polling interval information from the UE 1250. The reception component 1204 may be configured to send a signal associated with the polling interval information to the polling interval component 1206.

In certain other configurations, the polling interval component 1206 may be configured to determine a polling interval for the UE 1250 when the one or more subscriptions are not available. In certain aspects, the polling interval may be determined based on one or more of information stored in the provisioning entity or polling interval information sent by the UE 1250. The polling interval component 1206 may be configured to send a signal associated with the polling interval configuration information to the transmission component 1210 and/or the subscription provisioning component 1208.

In certain configurations, the transmission component 1210 may be configured to send at least a polling interval to the UE 1250 when the one or more subscriptions are not available. In certain other aspects, the polling interval configuration information sent by the UE 1250 may include one or more of polling interval stored in the UE 1250, UE type, subscription request index, battery state of the UE, or an IP address change detected by the UE 1250.

In certain configurations, the reception component 1204 may be configured to receive a second subscription request message after the polling interval when the one or more subscriptions are not available in response to the first subscription request. The reception component 1204 may be configured to send a signal associated with the second subscription request message to the subscription provisioning component 1208.

In certain configurations, the subscription provisioning component 1208 may be configured to determine when the one or more subscription(s) are available for the UE 1250. The subscription provisioning component 1208 may be configured to send a signal associated with the one or more subscription(s) to the transmission component 1210 when the subscription(s) are available.

In certain configurations, the transmission component 1210 may be configured to send the one or more subscriptions to the UE 1250 when the one or more subscriptions are available.

The apparatus may include additional components that perform each of the blocks of the algorithm in the aforementioned flowchart of FIG. 11. As such, each block in the aforementioned flowchart of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

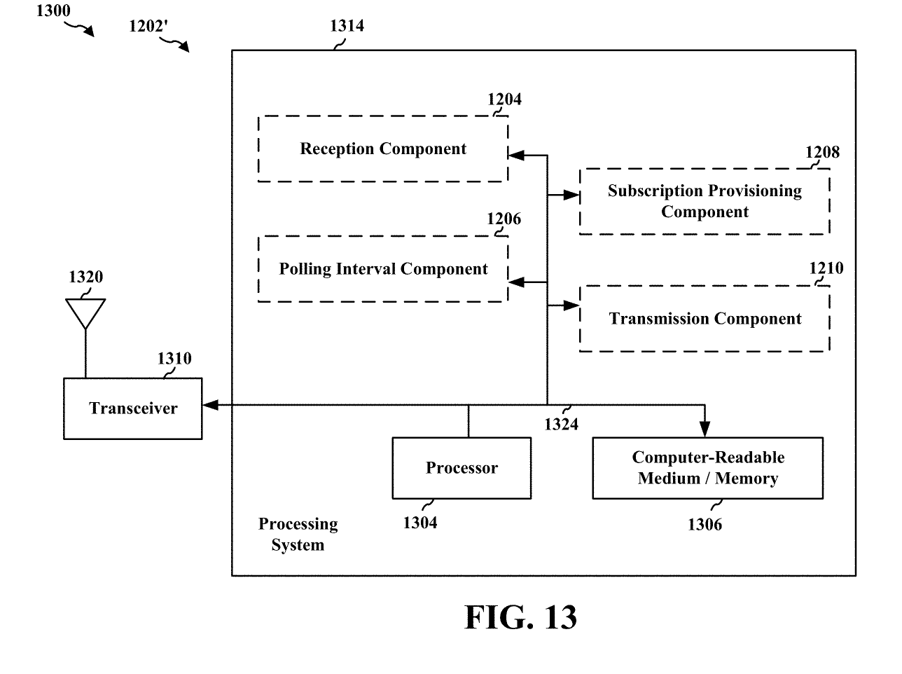

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor 1304, the components 1204, 1206, 1208, 1210, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1204. In addition, the transceiver 1310 receives information from the processing system 1314, specifically the transmission component 1210, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system 1314 further includes at least one of the components 1204, 1206, 1208, 1210. The components may be software components running in the processor 1304, resident/stored in the computer readable medium/memory 1306, one or more hardware components coupled to the processor 1304, or some combination thereof. The processing system 1314 may be a component of the base station 310 and may include the memory 376 and/or at least one of the TX processor 316, the RX processor 370, and the controller/processor 375.

In certain configurations, the apparatus 1202/1202′ for wireless communication may include means for receiving a first subscription request message from a UE. In certain aspects, the first subscription request message may request one or more subscriptions. In certain other aspects, each subscription may include at least one or more credentials. In certain other configurations, the apparatus 1202/1202′ for wireless communication may include means for sending at least a polling interval to the UE when the one or more subscriptions are not available. In certain aspects, the polling interval may be determined based on one or more of information stored in the provisioning entity or information sent by the UE. In certain other aspects, the information sent by the UE may include one or more of polling interval stored in the UE, UE type, subscription request index, battery state of the UE, or an IP address change detected by the UE. In certain other configurations, the apparatus 1202/1202′ for wireless communication may include means for receiving a second subscription request message after the polling interval when the one or more subscriptions are not available in response to the first subscription request. In certain other configurations, the apparatus 1202/1202′ for wireless communication may include means for sending the one or more subscriptions to the UE when the one or more subscriptions are available. The aforementioned means may be one or more of the aforementioned components of the apparatus 1202 and/or the processing system 1314 of the apparatus 1202′ configured to perform the functions recited by the aforementioned means. As described supra, the processing system 1314 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
sending a first subscription request message to a provisioning entity, the first subscription request message requesting one or more subscriptions, wherein each subscription includes at least one or more credentials;
receiving the one or more subscriptions from the provisioning entity when the one or more subscriptions are available; and
sending a second subscription request message after a polling interval to the provisioning entity when the one or more subscriptions are not received.

2. The method of claim 1, wherein the first subscription request message is associated with one or more of internet protocol (IP) information of the UE or an identifier of a serving network of the UE.

3. The method of claim 2, wherein the IP information includes an IP address associated with the UE.

4. The method of claim 2, further comprising:
receiving a message from the provisioning entity indicating that a subscription for the UE is available for provisioning, wherein a destination address of the message is associated with one or more the IP information of the UE or the identifier of the serving network of the UE.

5. The method of claim 1, further comprising:
determining the polling interval based at least in part on one or more of a current polling interval maintained by the UE, UE type, subscription request index, battery state of the UE, an IP address change detected by the UE, a change of a serving network identifier detected by the UE, a determination made by an application running in the UE that the UE needs a new subscription, unsatisfactory coverage for a current serving network detected by the UE, or unsatisfactory connectivity obtained using a current subscription detected by the UE.

6. The method of claim 1, further comprising:
receiving first information from the provisioning entity that configures the UE with the polling interval.

7. The method of claim 6, further comprising:
sending second information to the provisioning entity including one or more of a current polling interval maintained by the UE, UE type, subscription request index, battery state of the UE, or an IP address change detected by the UE, wherein the first information is based at least in part on the second information.

8. The method of claim 1, wherein the second subscription request message is sent when the one or more subscriptions are not received in response to the first subscription request message.

9. The method of claim 1, wherein the first subscription request message and the second subscription request message are sent when the provisioning entity is determined to be preferred based on information maintained by the UE.

10. A method of wireless communication of a provisioning entity, comprising:
receiving a first subscription request message from a user equipment (UE), the first subscription request message requesting one or more subscriptions, wherein each subscription includes at least one or more credentials, and the first subscription request message is associated with one or more of internet protocol (IP) information associated with the UE or an identifier of a serving network of the UE;
sending the one or more subscriptions to the UE when the one or more subscriptions are available;
maintaining a correlation between the one or more of the IP information associated with the UE or the identifier of the serving network of the UE, and the one or more subscriptions requested by the UE when the one or more subscriptions are not available; and
initiating the sending of the one or more subscriptions to the UE using the one or more of the IP information associated with the UE or the identifier of the serving network of the UE when the one or more subscriptions are ready without receiving a subsequent subscription request message from the UE.

11. The method of claim 10, wherein the IP information includes one or more of an IP address associated with the UE.

12. The method of claim 10, further comprising:
receiving a second subscription request message after a polling interval when the one or more subscriptions are not available in response to the first subscription request message.

13. A method of wireless communication of a provisioning entity, comprising:
receiving a first subscription request message from a user equipment (UE), the first subscription request message requesting one or more subscriptions, wherein each subscription includes at least one or more credentials;
sending the one or more subscriptions to the UE when the one or more subscriptions are available; and
sending at least a polling interval to the UE when the one or more subscriptions are not available, wherein the polling interval is determined based on one or more of information stored in the provisioning entity or information sent by the UE, and wherein the information sent by the UE includes one or more of polling interval stored in the UE, UE type, subscription request index, battery state of the UE, or an IP address change detected by the UE.

14. The method of claim 13, further comprising:
receiving a second subscription request message after the polling interval when the one or more subscriptions are not available in response to the first subscription request message.

15. An apparatus for wireless communication of a user equipment (UE), comprising:
means for sending a first subscription request message to a provisioning entity, the first subscription request message requesting one or more subscriptions, wherein each subscription includes at least one or more credentials;
means for receiving the one or more subscriptions from the provisioning entity when the one or more subscriptions are available; and
means for sending a second subscription request message after a polling interval to the provisioning entity when the one or more subscriptions are not received.

16. The apparatus of claim 15, wherein the first subscription request message is associated with one or more of internet protocol (IP) information of the UE or an identifier of a serving network of the UE.

17. The apparatus of claim 16, wherein the IP information includes an IP address associated with the UE.

18. The apparatus of claim 16, further comprising:
means for receiving a message from the provisioning entity indicating that a subscription for the UE is available for provisioning, wherein a destination address of the message is associated with one or more the IP information of the UE or the identifier of the serving network of the UE.

19. The apparatus of claim 15, further comprising:
means for determining the polling interval based at least in part on one or more of a current polling interval maintained by the UE, UE type, subscription request index, battery state of the UE, an IP address change detected by the UE, a change of a serving network identifier detected by the UE, a determination made by an application running in the UE that the UE needs a new subscription, unsatisfactory coverage for a current serving network detected by the UE, or unsatisfactory connectivity obtained using a current subscription detected by the UE.

20. The apparatus of claim 15, further comprising:
means for receiving first information from the provisioning entity that configures the UE with the polling interval.

21. The apparatus of claim 20, further comprising:
means for sending second information to the provisioning entity including one or more of a current polling interval maintained by the UE, UE type, subscription request index, battery state of the UE, or an IP address change detected by the UE, wherein the first information is based at least in part on the second information.

22. The apparatus of claim 15, wherein the second subscription request message is sent when the one or more subscriptions are not received in response to the first subscription request message.

23. The apparatus of claim 15, wherein the first subscription request message and the second subscription request message are sent when the provisioning entity is determined to be preferred based on information maintained by the UE.

24. An apparatus for wireless communication of a provisioning entity, comprising:
means for receiving a first subscription request message from a user equipment (UE), the first subscription request message requesting one or more subscriptions, wherein each subscription includes at least one or more credentials, and the first subscription request message is associated with one or more of internet protocol (IP) information associated with the UE or an identifier of a serving network of the UE;
means for sending the one or more subscriptions to the UE when the one or more subscriptions are available;
means for maintaining a correlation between the one or more of the IP information associated with the UE or the identifier of the serving network of the UE, and the one or more subscriptions requested by the UE when the one or more subscriptions are not available; and
means for initiating the sending of the one or more subscriptions to the UE using the one or more of the IP information associated with the UE or the identifier of the serving network of the UE when the one or more subscriptions are ready without receiving a subsequent subscription request message from the UE.

25. The apparatus of claim 24, wherein the IP information includes one or more of an IP address associated with the UE.

26. The apparatus of claim 24, further comprising:
means for receiving a second subscription request message after a polling interval when the one or more subscriptions are not available in response to the first subscription request message.

27. An apparatus for wireless communication of a provisioning entity, comprising:
means for receiving a first subscription request message from a user equipment (UE), the first subscription request message requesting one or more subscriptions, wherein each subscription includes at least one or more credentials;
means for sending the one or more subscriptions to the UE when the one or more subscriptions are available; and
means for sending at least a polling interval to the UE when the one or more subscriptions are not available, wherein the polling interval is determined based on one or more of information stored in the provisioning entity or information sent by the UE, wherein the information sent by the UE includes one or more of polling interval stored in the UE, UE type, subscription request index, battery state of the UE, or an IP address change detected by the UE.

28. The apparatus of claim 27, further comprising:
means for receiving a second subscription request message after the polling interval when the one or more subscriptions are not available in response to the first subscription request message.

29. An apparatus for wireless communication of a user equipment (UE), comprising:
a memory; and
at least one processor coupled to the memory and configured to:
send a first subscription request message to a provisioning entity, the first subscription request message requesting one or more subscriptions, wherein each subscription includes at least one or more credentials;
receive the one or more subscriptions from the provisioning entity when the one or more subscriptions are available; and
send a second subscription request message after a polling interval to the provisioning entity when the one or more subscriptions are not received.

30. The apparatus of claim 29, wherein the first subscription request message is associated with one or more of internet protocol (IP) information of the UE or an identifier of a serving network of the UE.

31. The apparatus of claim 30, wherein the IP information includes an IP address associated with the UE.

32. The apparatus of claim 30, wherein the at least one processor is further configured to:
receive a message from the provisioning entity indicating that a subscription for the UE is available for provisioning, wherein a destination address of the message is associated with one or more the IP information of the UE or the identifier of the serving network of the UE.

33. The apparatus of claim 29, wherein the at least one processor is further configured to:
determine the polling interval based at least in part on one or more of a current polling interval maintained by the UE, UE type, subscription request index, battery state of the UE, an IP address change detected by the UE, a change of a serving network identifier detected by the UE, a determination made by an application running in the UE that the UE needs a new subscription, unsatisfactory coverage for a current serving network detected by the UE, or unsatisfactory connectivity obtained using a current subscription detected by the UE.

34. The apparatus of claim 29, wherein the at least one processor is further configured to:
receive first information from the provisioning entity that configures the UE with the polling interval.

35. The apparatus of claim 34, wherein the at least one processor is further configured to:
send second information to the provisioning entity including one or more of a current polling interval maintained by the UE, UE type, subscription request index, battery state of the UE, or an IP address change detected by the UE, wherein the first information is based at least in part on the second information.

36. The apparatus of claim 29, wherein the second subscription request message is sent when the one or more subscriptions are not received in response to the first subscription request message.

37. The apparatus of claim 29, wherein the first subscription request message and the second subscription request message are sent when the provisioning entity is determined to be preferred based on information maintained by the UE.

38. An apparatus for wireless communication of a provisioning entity, comprising:
a memory; and
at least one processor coupled to the memory and configured to:
receive a first subscription request message from a user equipment (UE), the first subscription request message requesting one or more subscriptions, wherein each subscription includes at least one or more credentials, and the first subscription request message is associated with one or more of internet protocol (IP) information associated with the UE or an identifier of a serving network of the UE;
send the one or more subscriptions to the UE when the one or more subscriptions are available;
maintain a correlation between the one or more of the IP information associated with the UE or the identifier of the serving network of the UE, and the one or more subscriptions requested by the UE when the one or more subscriptions are not available; and
initiate the sending of the one or more subscriptions to the UE using the one or more of the IP information associated with the UE or the identifier of the serving network of the UE when the one or more subscriptions are ready without receiving a subsequent subscription request message from the UE.

39. The apparatus of claim 38, wherein the IP information includes one or more of an IP address associated with the UE.

40. The apparatus of claim 38, wherein the at least one processor is further configured to:
receive a second subscription request message after a polling interval when the one or more subscriptions are not available in response to the first subscription request message.

41. An apparatus for wireless communication of a provisioning entity, comprising:
a memory; and
at least one processor coupled to the memory and configured to:
receive a first subscription request message from a user equipment (UE), the first subscription request message requesting one or more subscriptions, wherein each subscription includes at least one or more credentials;
send the one or more subscriptions to the UE when the one or more subscriptions are available; and
send at least a polling interval to the UE when the one or more subscriptions are not available, wherein the polling interval is determined based on one or more of information stored in the provisioning entity or information sent by the UE, wherein the information sent by the UE includes one or more of polling interval stored in the UE, UE type, subscription request index, battery state of the UE, or an IP address change detected by the UE.

42. The apparatus of claim 41, wherein the at least one processor is further configured to:
receive a second subscription request message after the polling interval when the one or more subscriptions are not available in response to the first subscription request message.

43. A computer-readable medium comprising computer executable code of a user equipment (UE), comprising code to:
send a first subscription request message to a provisioning entity, the first subscription request message requesting one or more subscriptions, wherein each subscription includes at least one or more credentials;
receive the one or more subscriptions from the provisioning entity when the one or more subscriptions are available; and
send a second subscription request message after a polling interval to the provisioning entity when the one or more subscriptions are not received.

44. The computer-readable medium of claim 43, wherein the first subscription request message is associated with one or more of internet protocol (IP) information of the UE or an identifier of a serving network of the UE.

45. The computer-readable medium of claim 44, wherein the IP information includes an IP address associated with the UE.

46. The computer-readable medium of claim 44, further comprising code to:
receive a message from the provisioning entity indicating that a subscription for the UE is available for provisioning, wherein a destination address of the message is associated with one or more the IP information of the UE or the identifier of the serving network of the UE.

47. The computer-readable medium of claim 43, further comprising code to:
determine the polling interval based at least in part on one or more of a current polling interval maintained by the UE, UE type, subscription request index, battery state of the UE, an IP address change detected by the UE, a change of a serving network identifier detected by the UE, a determination made by an application running in the UE that the UE needs a new subscription, unsatisfactory coverage for a current serving network detected by the UE, or unsatisfactory connectivity obtained using a current subscription detected by the UE.

48. The computer-readable medium of claim 43, further comprising code to:
receive first information from the provisioning entity that configures the UE with the polling interval.

49. The computer-readable medium of claim 48, further comprising code to:
send second information to the provisioning entity including one or more of a current polling interval maintained by the UE, UE type, subscription request index, battery state of the UE, or an IP address change detected by the UE, wherein the first information is based at least in part on the second information.

50. The computer-readable medium of claim 43, wherein the second subscription request message is sent when the one or more subscriptions are not received in response to the first subscription request message.

51. The computer-readable medium of claim 43, wherein the first subscription request message and the second subscription request message are sent when the provisioning entity is determined to be preferred based on information maintained by the UE.

52. A computer-readable medium comprising computer executable code of a provisioning entity, comprising code to:
receive a first subscription request message from a user equipment (UE), the first subscription request message requesting one or more subscriptions, wherein each subscription includes at least one or more credentials, and the first subscription request message is associated with one or more of internet protocol (IP) information associated with the UE or an identifier of a serving network of the UE;
send the one or more subscriptions to the UE when the one or more subscriptions are available;
maintain a correlation between the one or more of internet protocol (IP) information associated with the UE or the identifier of the serving network of the UE, and the one or more subscriptions requested by the UE when the one or more subscriptions are not available; and
initiate the sending of the one or more subscriptions to the UE using the one or more of the IP information associated with the UE or the identifier of the serving network of the UE when the one or more subscriptions are ready without receiving a subsequent subscription request message from the UE.

53. The computer-readable medium of claim 52, wherein the IP information includes one or more of an IP address associated with the UE.

54. The computer-readable medium of claim 52, further comprising code to:
receive a second subscription request message after a polling interval when the one or more subscriptions are not available in response to the first subscription request message.

55. A computer-readable medium comprising computer executable code of a provisioning entity, comprising code to:
receive a first subscription request message from a user equipment (UE), the first subscription request message requesting one or more subscriptions, wherein each subscription includes at least one or more credentials;
send the one or more subscriptions to the UE when the one or more subscriptions are available; and
send at least a polling interval to the UE when the one or more subscriptions are not available, wherein the polling interval is determined based on one or more of information stored in the provisioning entity or information sent by the UE, wherein the information sent by the UE includes one or more of polling interval stored in the UE, UE type, subscription request index, battery state of the UE, or an IP address change detected by the UE.

56. The computer-readable medium of claim 55, further comprising code to:
receive a second subscription request message after the polling interval when the one or more subscriptions are not available in response to the first subscription request message.
